(19) United States
(12) Patent Application Publication
(10) Pub. No.: US 2015/0081364 A1
(43) Pub. Date: Mar. 19, 2015

(54) Rating and Bidding Method for a Teleradiology Workflow System

(71) Applicant: Doug K. Smith, San Antonio, TX (US)

(72) Inventor: Doug K. Smith, San Antonio, TX (US)

(73) Assignee: Virtual Viewbox, LLC, San Antonio, TX (US)

(21) Appl. No.: 14/303,571

(22) Filed: Jun. 12, 2014

Related U.S. Application Data
(62) Division of application No. 13/354,219, filed on Jan. 19, 2012.

(51) Int. Cl. G06Q 50/22; G06Q 10/06; G06Q 30/02

(52) U.S. Cl. CPC G06Q 50/22; G06Q 30/0282; G06Q 10/063112
USPC 705/7.14; 705/347

(57) ABSTRACT

A method for rating participants within a radiologic referral communication system incorporates a variety of data points entered by participants within the radiological referral communications system. Further, the related method of bidding on the services of participants incorporates data inputted by participants the radiological referral communications system.

### TECHNICAL FIELD

The present disclosure relates generally to communication systems and in particular to a system and method for enabling a physician to generate a Session Initiation Protocol (hereinafter “SIP”) based patient preorder workfile before a computerized provider order entry is created and augment the patient preorder workfile in real time where the patient preorder workfile integrates with an electronic medical records system, such as among others a Picture Archiving and Communication System (hereinafter “PACS”), after the provider order entry is created.

### BACKGROUND

Recently, as trends in healthcare administration rapidly move from analog paper files and telephones toward mobile broadband device operations of the 21^{st} century, the variety of and speed by which applications offered by mobile devices continues to significantly improve. Today radiological medicine is moving toward benefiting from the advancements of mobile broadband and away from the “brick and mortar” legacy systems that promote analog paper files and imaging films as well as significantly arduous efforts in preparing an order for a patient radiological report.

In particular, the need for an energy efficient, cost and time saving radiological platform is significantly critical in the field of military medicine. The present United States conflicts in the Middle East and the other turbulent areas throughout the world continue to produce many patients that suffer from critical injuries. Of the utmost urgency in military medicine today relates to those who are subject to an unprecedented number of traumatic brain injuries that principally arise from encountering improvised explosive devices (IEDs) in remote and rugged locations that lack nearby clinics or any civic infrastructure for facilitating westernized medical care. Traumatic brain and other injuries are indicative of the current state of military medicine where, although more soldiers are surviving from combat, a greater number of injuries must now be accounted for while located at remote battlefields.

Traumatic brain injuries, often referred to as the single ailment that best reflects the contemporary conflicts in the Middle East and in the future, result in patients who chronically suffer from diminished motor skills, emotional irregularity, psychological instability, to acute episodes of post-traumatic stress that each directly effect a highly skilled military fighting force from performing their basic roles such as firing a weapon and quickly surveying troubled areas. To better understand this timely affliction as well as diagnose other physical injuries, the United States military over the past year has created and logistically deployed at a remote area of Afghanistan what is historically noted to be the first Magnetic Resonance Imaging (MRI) systems ever operating from within an active war zone.

Unfortunately, these mobile imaging systems must reliably operate with a limited number of healthcare professionals and related resources as would otherwise be amply available in a standard clinical venue elsewhere. Moreover, on-site healthcare administrators are often nonexistent at such a rugged and remote area within a combat zone.

Accordingly, there exists a need for a system and method for assisting a remote referring healthcare professional, such as a combat medic in the field or a referring physician at the combat MRI system, that is assessing a patient's needs by quickly and simply interfacing with other professional participants and updated policy configurations on at least one social network to provide expertise and information that is lacking at the remote referring professional's locale. Moreover, there exists a further need for allowing that referring healthcare professional to augment their patient assessment in real time without the physical presence of actual healthcare administration.

Generally, within the broader field of teleradiology, there exists a need for a referring physician to assess a patient's concerns while leveraging mobile broadband technology to provide health care administration assistance. In particular, the need exists for the referring physician to simply and immediately create a draft version or “precursor” of a physician order entry with a broadband device while seeing the patient. As such, before final preparation of the referring physician's work order is made for a radiologists' report that will be responsive to the patient's aliment, the need exists for a preorder casefile to interface with at least one radiology social network referral system to provide highly patient-specific and timely insight to referring physician while seeing the patient. Moreover, similar to the specific instance within military medicine, there exists a broader need in the field of teleradiology for enabling a referring healthcare professional to augment their patient assessment in real time. Accordingly, there is a need for system and method for preorder teleradiology workflow.

### BRIEF DESCRIPTION OF THE FIGURES

The accompanying figures, where like reference numerals refer to identical or functionally similar elements throughout the separate views, together with the detailed description below, are incorporated in and form part of the specification and serve to further illustrate various embodiments of concepts that include the claimed invention, and to explain various principles and advantages of those embodiments.

FIG. 1, in general, is a system diagram illustrating a radiology social network referral system in accordance with embodiments of the present disclosure featuring at least one dashboard, each dashboard generating, via a referring physician, a patient preorder workfile in response to a corresponding patient need where each dashboard includes a real-time augmentation function for altering the generated patient preorder workfile at any time, FIG. 1a is a detailed system diagram of the radiology social network referral system of FIG. 1;

FIG. 2 is a schematic diagram illustrating at least one ranged selection set provided by each dashboard, the at least one selection set receives, at least in part, shared data input from a radiology referral system in real time to assist the referring physician with current, highly patient specific decisions in either generating or augmenting a corresponding patient preorder workfile;

FIG. 3 is a schematic diagram generally illustrating a graphical user interface defining a dashboard that includes a real-time augmentation function, the dashboard shows a plurality of patient preorder workfiles;

FIG. 4 is a schematic diagram showing at least one graphical user interface of a referring physician dashboard including a real-time augmentation function, the dashboard shows a plurality of patient preorder workfiles that shows, for illustrative purposes, the referring physician choosing an imaging center from a plurality of participants types, choosing a imaging center from ranged selection sets associated with a participant policy configuration, choosing a specific imaging center “D”, and choosing from a range of highest rated imaging center technologists provided by a selection set that is based on shared information data received from a radiology social network referral system;

FIG. 5 is a schematic diagram showing the at least one graphical user interface of the referring physician dashboard of FIG. 4 that shows, for illustrative purposes, the referring physician choosing an individual radiologist from ranged selection sets associated with the highest rated, most rated, and shortest turn-around time for each radiologist based on shared information data received from a radiology social network referral system, choosing from a range of insurance providers shared by an imaging center and corresponding patient, and choosing a possible mutually agreeable discount between the selected imaging center and corresponding patient; and

FIG. 6 is a bit layout of one illustrative embodiment of a patient preorder workfile packet header.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, the present disclosure provides a system and method for healthcare administration and, in particular, radiologic practice workflow. A referring physician applies chosen selection sets of policy configurations to at least one dashboard before a work request or “order” is placed by the referring physician. Each dashboard includes a real-time augmentation function and a plurality of ranged selection sets of policy configurations whereby each selection set is initially created by the referring physician. The policy configurations are updated in real time with, at least in part, shared data input received at a group application function of a radiology social network referral system.

Moreover, the referring physician generates a patient preorder workfile with at the at least one dashboard in response to a patient need. A group application function collects data input for the patent preorder workfile. After a physician order entry is entered, the patient preorder workfile is interfaced with an electronic medical record system of a type well known in the industry. Illustratively, in one embodiment, the patient preorder workfile is interfaced with a PACS.

Illustratively, the radiology social network referral system is applicable to the field of military medicine, among other fields. Accordingly, the radiology social network system provides healthcare administration remotely as well as establishes real time access to a social network of rated, highly trained specialists that would have otherwise not have been available through conventional “brick and mortar” healthcare administration legacy systems, such as among others those that are often referenced as “outside network providers”.

The radiology social network referral system is exceptionally beneficial in both military and private teleradiology and is critically needed in current battlefield settings. Presently, because of the urgent concerns toward an increasing number of soldiers subjected to traumatic brain injury, the United States military has recently established a mobile MRI and radiology facility within a remote combat zone.

Because of the current logistics of the United States military sending equipment and personnel to remote, hazardous areas across the globe requires a lot of fuel (including hydrocarbon fossil fuels), personnel, and natural resources at tremendous costs, the radiology social network referral system efficiently provides remotely networked healthcare administration that ideally complements the established mobile systems, saves expenditure of hydrocarbon fuels in that this networked system practically eliminates the need for the physical logistics of transporting heavy equipment and personnel throughout the world, and is environmentally friendly, green technology in that it eliminates the need of medical paper files and chemically reactive films by providing a computer readable formatted system as the alternative.

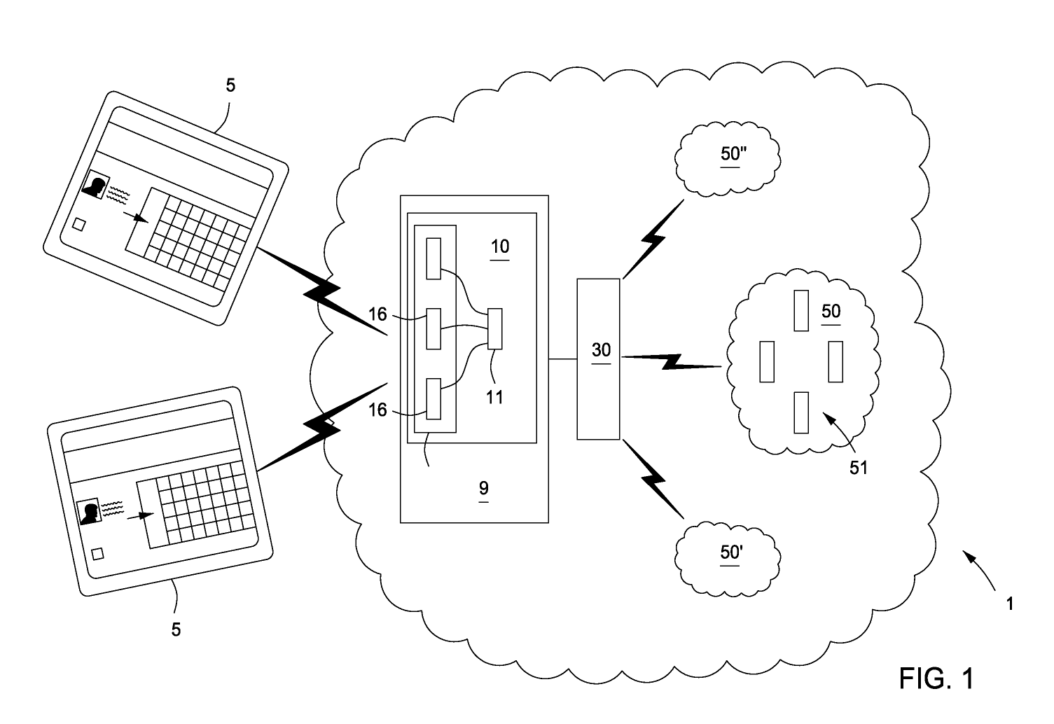

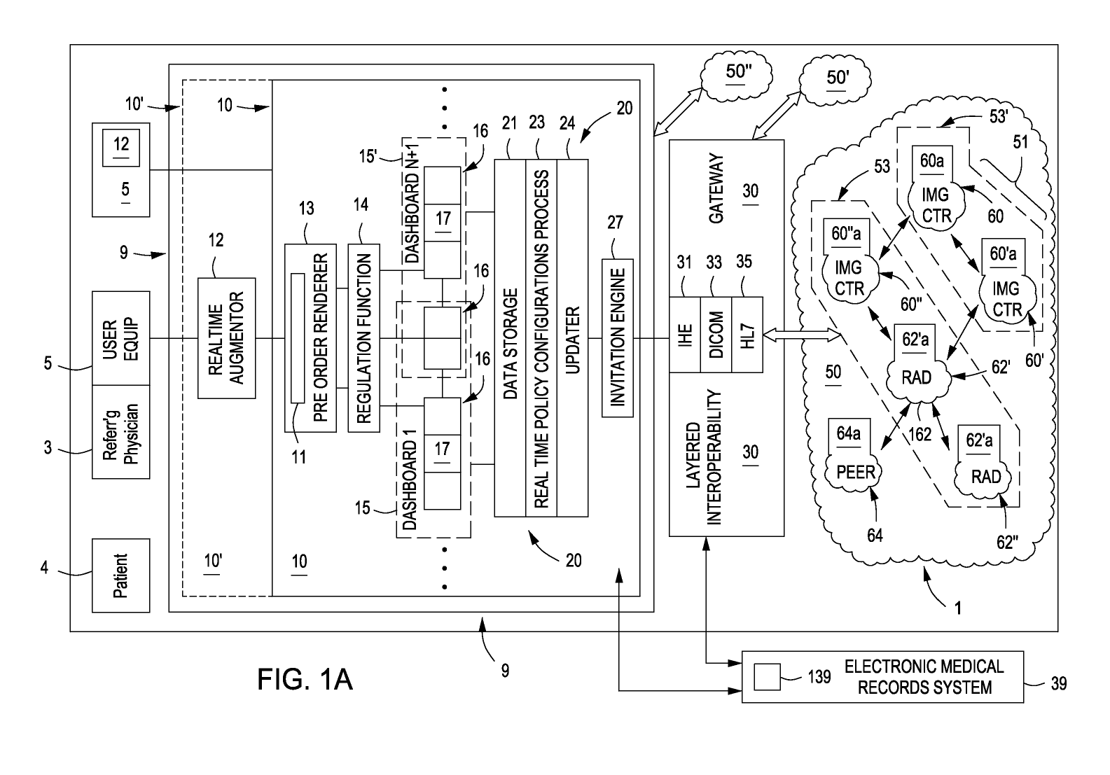

Illustrative embodiments of the present disclosure and appended claims, as described below, are generally applicable to the radiology social network referral system that includes a plurality of networks defining a radiology referral system, an interoperability gateway, a healthcare administration server, and at least one subscriber unit (shown in FIG. 1 as user equipment (UE) 5). Each of the networks includes a number of infrastructure devices for facilitating communications for the subscriber units operating in the system. Such infrastructure devices include elements of a radio access network (RAN) or simply access network that communicate with the subscriber units via an air interface, such as for instance, eNodeBs, base radios, base stations, base transceiver stations, and the like. Such infrastructure devices further include elements of an infrastructure core (e.g., an Evolved Packet Core (EPC) in an LTE system) used to manage the allocation of radio resources of the network, with the infrastructure core including elements such as for instance, Mobility Management Entities, Signaling Gateways, Packet Data Network Gateways, etc. Other infrastructure devices that may be included in any one or each of the disclosed networks includes, but are not limited to, switches, zone controllers, base station controllers, repeaters, access points, routers, etc.

In an embodiment, the radiology social network referral system that includes radiologic referral social networks comprises a 3GPP (3^{rd} Generation Partnership Project) Long Term Evolution (LTE)-based network. Illustratively, in at least one embodiment, the radiology social network referral system for the embodiment of FIGS. 1 and 1a may comprise either a private LTE system, such as among others a military LTE system or a public LTE system, such as among others a commercial carrier mobile phone LTE system. However, the plurality of networks can comprise any combination of 3GPP (3^{rd} Generation Partnership Project), broadband, legacy or non-3GPP radio access type systems including, but not limited to LTE systems, Wireless Local Area Network (WLAN) systems, and Code Division Multiple Access (CDMA) systems, GPRS (general packet radio service) systems, Land Mobile Radio (LMR) systems, and WiMAX (Worldwide Interoperability for Microwave Access) systems. Among other messaging applications, mobile devices and other telecommunication systems are increasingly relying on internet protocols such as Session Initiation Protocol (SIP) for creating, modifying, and terminating communication sessions with one or more participants using a combination of multimedia applications, such as for voice and video.

Illustrative embodiments of the present disclosure and appended claims, as described below, are applicable to any type of Session Internet Protocol (SIP) message, such as, among others, SIP request messages including SIP Invite messages, SIP Response messages including 200 OK messages, Session Initiation Protocol for Instant Message Leveraging Extensions (SIMPLE) messaging, and Message Session Relay Protocol (MSRP) messaging.

At times, as described herein for purposes of this disclosure and appended claims, the terms “Referring Physician”, “Physician”, “Combat Medic”, “Health Provider”, “Technician”, “Imaging Center”, “Peer”, “Originator”, “Participant”, “Node”, “User”, “User Agent Client”, “Client”, “Subscriber(s)” and “Source/Destination Endpoint” are used interchangeably for a logical network endpoint that transmits or receives SIP messages through a user agent server. It is understood that “subscriber” refers to one or more operators of user equipment (UE). Those of ordinary skill in the art will readily recognize various embodiments for UE, for purposes of illustration in this disclosure, the UE comprises either a wireless mobile device, such as among others a tablet computer, or a wired device, such as among others a desktop computer. Moreover, as described herein for purposes of this disclosure and appended claims, the terms “radiology” and “teleradiology” are used interchangeably for field of radiological medicine.

The subscribers can be members of a “work request group”, “group” or “talk group” that include a combination of preconfigured users, ad hoc users or members. Alternatively, subscribers may not be members of such groups. As described herein, a communication group in a radiology social network referral system is referred to as a “work request group”, “request workgroup”, “social network group” or “group”. A radiology social network referral system features a plurality of social network groups where it is possible for a user to be a member of any combination of work request groups. Illustratively, in one embodiment, a request workgroup refers to all individuals and entities associated with a physician order entry including participants such as among others radiologists and imaging centers as well as the referring physician and corresponding patient. As a further illustration, an endpoint, such as participant radiologist assigned by a referring physician, may be a member of a work request group for a first patient, a work request group for a second patient, and a peer group. Each subscriber engages in a communication session by way of any combination of UE comprising hardware and software and/or firmware each interfacing with at least one corresponding dashboard.

As a radiology social network referral system 1 is discussed in greater detail below, a software application is installed in UE to strictly interface with the radiology social network referral system 1 that includes a health administration server 9. The radiology social network referral system 1 comprises a secured network, as required by both military purposes and healthcare regulations, such that all UE strictly access the health administration server 9 of which all data and commands are stored. In at least one embodiment, no restricted information is stored in the UE. Further, certain advantages of the methods as described herein are beneficial and may be applied to any type of user agent, such as a client or server, on the network.

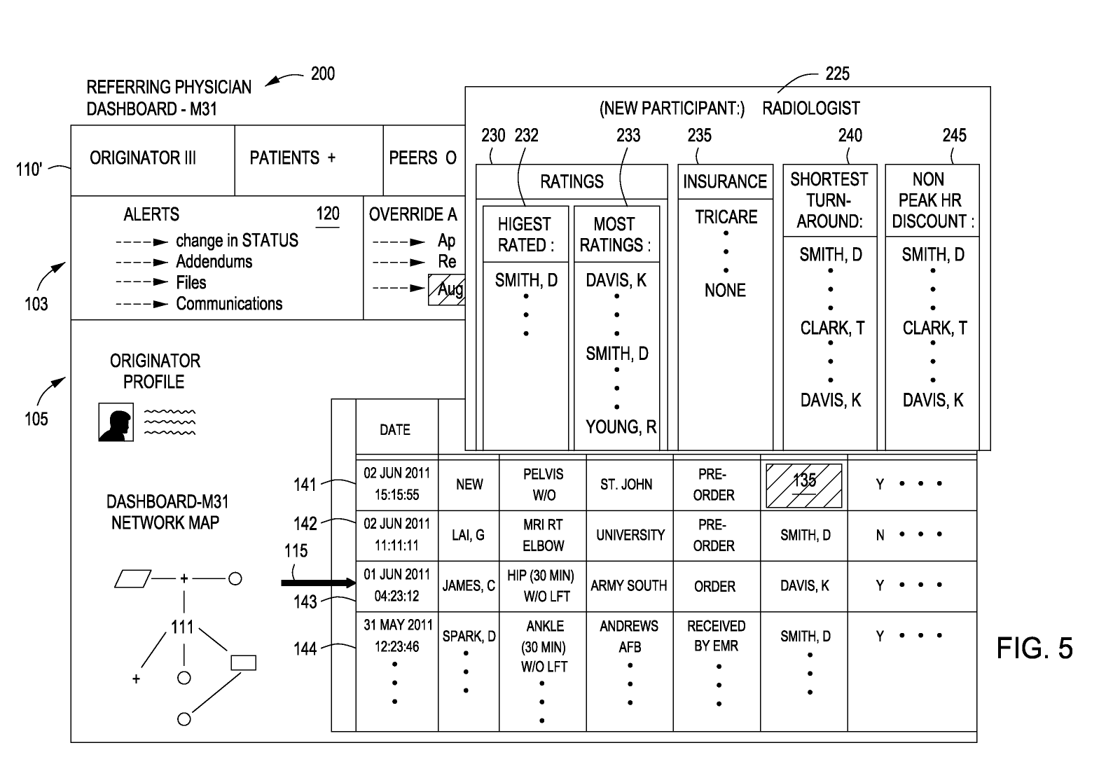

In this disclosure and appended claims the term “policy configuration” refers to social media policy guidelines, rules, categories, and commands for participants of the radiology social network referral system that post content such as among others reviews, helpful command instructions for participants including those participants of a request workgroup. In this disclosure and appended claims, the term “selection set” refers to data input that is arranged according to at least one particular policy configuration that acts to filter data input through selection sets that display a matrix of data input for specific user selections. For example, a referring physician determines that a new combat-injured patient needs the highest rated radiologist available anywhere in the world who will accept TRICARE military insurance such that the referring physician will use a dashboard to access a selection set for highest rated radiologist and a selection set for insurance to policy configurations to acquire the desired physician, see FIG. 5.

In this disclosure and appended claims the term “data input” refers to data that is provided by a radiology social network referral system and includes shared data input, such as reviews, ratings and postings, that is used for at least a plurality of participants in the radiology social network referral system including each radiologic referral social network and includes private data input.

In this disclosure and appended claims the term “real time” refers to denoting or relating to a computer system that constantly updates information at the same rate as the system receives data, and processes data sufficiently rapidly to be able to control a process. In this disclosure and appended claims the term “order” refers to the standard term “computerized physician order entry” or “computerized provider order entry”. In this disclosure and appended claims the term “patient preorder workfile” refers to an application in a computer readable format that is responsive to commands and information provided by a health administration server that is linked with the social network radiology referral system. Moreover, in one illustrative embodiment, a patient preorder workfile includes ERXRAY brand software suite, manufactured by Musculoskeletal Imaging Consultants of Texas, for the exchange of information and commands between the patient preorder workfile and the health server or the patient preorder workfile and the social network radiology referral system. Further, ERXRAY will serve as an interface with the imaging center's Radiology Information System (RIS) or online exam ordering software and the social network radiology referral system. In operation, depending on the specifics of the imaging center RIS, each patient preorder workfile is submitted through a variety of methods including, among others, HL7 connection, Secure Sockets Layer (SSL) internet connectivity, etc. ERXRAY is configured to operate with network interfaces and databases of a type well known in the industry. In at least one embodiment, a superseding alteration proposal message is sent by a health administration server, via the real-time augmentation function at a dashboard, and includes an update and an alteration acceptor function for optional activation by the client.

Alternatively, the server generates the superseding alteration proposal message without an alteration acceptor function for optional activation by the client. Illustratively, an endpoint radiologist client or a plurality of endpoint nodes would receive an alteration proposal message from the referring physician, via the UE, specifically requesting that only a summary abstract is required for a radiologists' report for all future work received by the referring physician where such an update is either optionally accepted by the receiving endpoint or is mandatory. An alternative embodiment provides mandatory alterations for uniform implementation when UE uniformity and rapid total performance are critical.

While embodiments of the present disclosure employ various teachings of the aforementioned standards and protocols, the embodiments as described herein are not limited by these protocols. Those skilled in the art will realize that the above recognized advantages and other advantages described herein are merely illustrative and are not meant to be a complete rendering of all of the advantages of the various embodiments.

Referring now to the figures, FIG. 1 generally illustrates a radiology social network referral system 1 and provides a general depiction of a physical implementation of various embodiments of the present disclosure. Specifically, the radiology social network referral system 1 is designed for implementation of various methods of generating, via a referring physician with at least one dashboard 15 in response to a patient need, a patient preorder workfile 11 and real time augmentation of such workfile 11. The radiology social network referral system 1 includes user equipment 5, such as a mobile device, that is linked to a health administration server 9. Generally, the health administration server 9 provides a secure platform for executing the methods of the radiology social network referral system 1 without compromising healthcare administration privacy obligations, such as among others compliance obligations under the Health Insurance Portability and Accountability Act (hereinafter “HIPPA”). Moreover, as discussed above, the UE 5 in one embodiment of the radiology social network referral system 1 provides a direct interface to the health administration server 9 such that no restricted data is stored in the UE 5.

As provided in greater detail below, the health administration server 9 comprises a plurality of servers for implementing a group application function 10, 10′ to provide a secure, utility or “cloud based” service over at least one network. Illustratively, in one embodiment, the group application function 10, 10′ assists such referring physicians in choosing, from among a plurality of ranged selection sets 16, the most appropriate radiologic service provider in response a patient need from a plurality of radiologic service providers before the referring physician authorizes an order entry. Accordingly, to facilitate the selections made by a referring physician, the group application function 10, 10′ provides at least one dashboard 15, 15′ as a graphical user interface for constructing a patient preorder workfile 11. In one embodiment, the patient preorder workfile 11 groups data, including shared data, for transport across the network of the radiology social network referral system 1, using among others a packet or a frame.

Moreover, as generally shown in FIG. 1, the radiology social network referral system 1 further includes a plurality of radiologic referral social networks 50, 50′, 50″. Each radiologic referral social network 50, 50′, 50″ includes a plurality of participants 51. The plurality of participants 51 includes individuals and institutions that provide services or products related to radiological medicine. As the radiology social network referral system 1 is social network based, each participant is encouraged to post content, review and rate other participants, and collaborate with other participants. To assist a referring physician with choosing the most appropriate radiologic provider in response a patient need, it is understood that at least one radiologic referral social network 50, 50′ 50″ includes participants that compete with other participants in providing the same services or products. In practice, each referring physician leverages the realtime updating feature provided by the health administration server 9 to review social network content from participants, including individual ratings and reviews, in choosing the most appropriate radiologic provider. Illustratively, the plurality of participants 51 is defined by a plurality of a radiologist practice groups that compete with one another such that each radiologist practice group as well as the groups' individual practitioners are reviewed, rated and encouraged by the radiology social network system 1 to provide content to better assist each referring physician in choosing the most appropriate radiologic provider in response to a specific patient need.

Furthermore, FIG. 1 generally shows a layered interoperability gateway 30. The layered interoperability gateway 30 is coupled between the health administration server 9 and the at least one radiologic referral social network 50, 50′, 50″. The layered interoperability gateway 30 joins the varied operating protocols of each radiologic referral social network 50, 50′, 50″ with the health administration server 9 while ensuring HIPAA compliance and medical privacy for medical imaging interoperability. Optionally, the layered interoperability gateway 30 provides data pointers to the health administration server 9 to access data located away, often hospital system proprietary data, from the health administration server 30 through the layered interoperability gateway 30.

In operation, as illustrated in the context of military medicine among other exemplary applications, a combat medic or referring physician in the battlefield assesses a wounded soldier for triage and initiates generation of a patient preorder workfile by interfacing with the health administration server 9 with the at least one dashboard 15 from the user equipment 5, such as an IPAD tablet. At that time, the health administration server 9 enables the combat medic in Afghanistan to make an informed decision with real time information provided by the administration server 9 to discern whether the mobile MRI unit is available and needed for this patient or will the patient be transported to another imaging center. Commonly, because of the danger of displacing metal within a magnetic field, combat medics must routinely assess whether a soldier's wounds suggest shrapnel which cannot be safely imaged by the mobile MRI unit without first being evaluated by either a computerized tomography (CT) scan or X-ray imaging center to first remove the shrapnel before employing the MRI. Accordingly, the user equipment 5 promptly informs the combat medic of the availability of the mobile MRI unit as well as other imaging centers, among other information.

Moreover, at the same time, the combat medic through UE 5 initiates a preliminary consultation with a civilian radiologist located in Texas on how best to prepare the patient for proper imaging where that civilian radiologist is a highly rated specialist within the radiology social network referral system 1 but who would otherwise be “inaccessibly” out of the current military healthcare provider network.

In the past, considerable quantities of hydrocarbon fuels and paperwork were expended in logistically transporting the patient to ultimately determine availability of a combat imaging center but not have the needed expertise to carry-out the imaging or even prepare the patient for imaging while on the battlefield. Often, in the past, the patient would first need to become processed with a standardized computerized Digital Imaging and Communications in Medicine (hereinafter “DICOM”) file format by on-site health administration professionals before even determining the most appropriate imaging center or obtain a preliminary consult from the radiologist. In effect, the radiology social network referral system 1 enables the combat medic or referring physician to personally make quick, critical initial decisions while with the patient well before a DICOM file format is assigned and before health administration professionals process the computerized physician order entry.

Specifically, FIG. 1a provides detailed system diagram of the radiology social network referral system 1 of FIG. 1. Inasmuch, FIG. 1a shows the user equipment 5, the health administration sever 9, a plurality of radiologic referral social networks 50, 50′, 50″ and a layered interoperability gateway 30 as described above. Moreover, at least one dashboard 15, 15′ each includes a plurality of selection sets 16 for a referring physician 3 to make the appropriate decisions in response to a patient's 4 medical needs in generating the patient preorder workfile 11 through the graphical user interfaces provided by the at least one dashboard 15, 15′.

FIG. 1a shows two alternative embodiments of a group application function 10, 10′ provided by the health administration server 9. For the embodiment of the group application function 10, the real time augmentor 12 application function is an independent function that is linked to the group application function 10. For example, in one embodiment, the real time augmentor 12 is integrated with the user equipment 5. For the embodiment of the group application function 10′, the real time augmentor 12 application function is integrated with the group application function 10′.

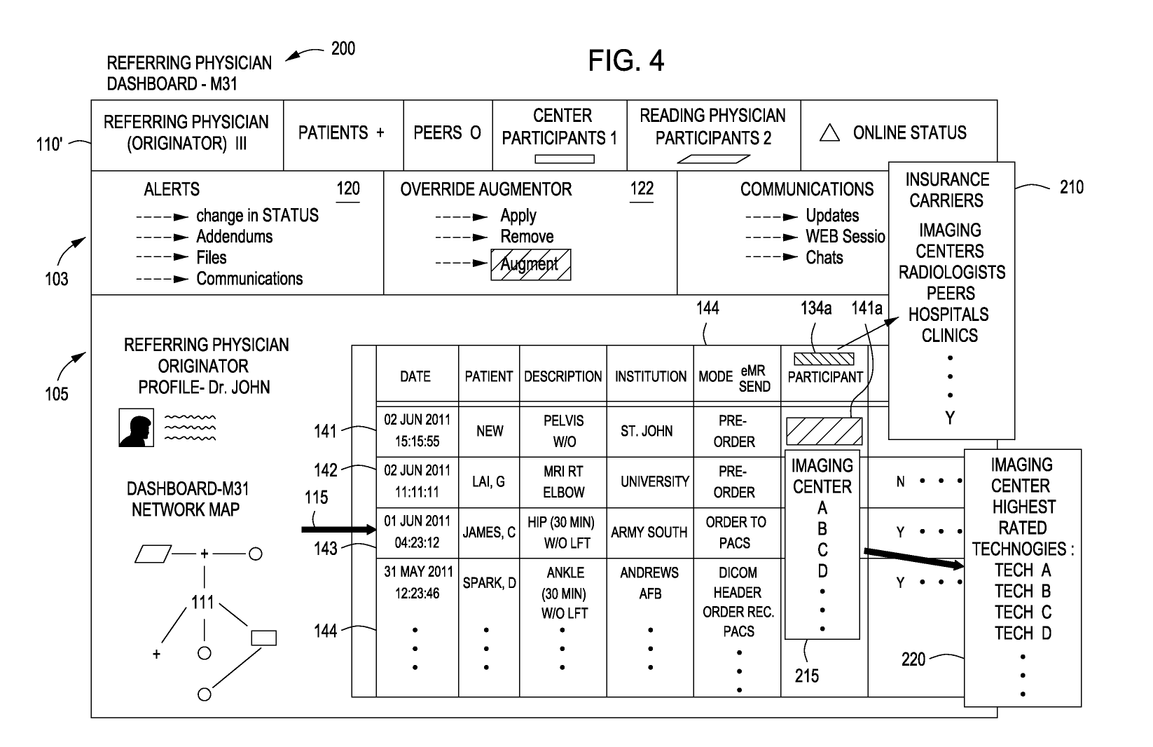

Operatively, the real time augmentor 12 alters the patient preorder workfile. As such, the real time augmentor 12 may alter the patient preorder workfile at any time in the corresponding workflow including before, during or after a DICOM file header is assigned by healthcare administration. In one embodiment, alterations include, among others, changes chronological sequence of the order, changes in participants, and network updates. As discussed further below, FIG. 4 generally depicts a graphical user interface for operating the real time augmentor 12 shown on a dashboard 100 as an override augmentor 122.

FIG. 1a shows the health administration server 9 in greater detail. The health administration server 9 includes the group application function 10, 10′. As shown, the patient preorder workfile 11 is specifically generated by a preorder renderer 12. The preorder renderer 12 is linked to the at least one dashboard 15, 15′ via a regulation function 14.

The regulation function 14 facilitates at least two actions. Firstly, the regulation function 14 ensures that data input 19 representing the selected policy configuration 17 from each selection set 16 is provided for implementation by the patient preorder workfile 11. Thereafter, the real time augmentor 12 changes the selected data input associated with the patient preorder workfile 11.

Secondly, the regulation function 14 specifically generates each dashboard 15 according to the ad hoc requirements provided by the referring physician via the user equipment 5. In effect, each dashboard is custom built or “taught” by commands received from the referring physician 3. Illustratively, in one embodiment, specific policy configurations that are of significance to a particular referring physician are then used as a category or policy configuration that forms the basis of a corresponding selection set that is initially added to a new dashboard. Each policy configuration will filter data input as the categorized selection set provides a range of data input options for the referring physician to choose from.

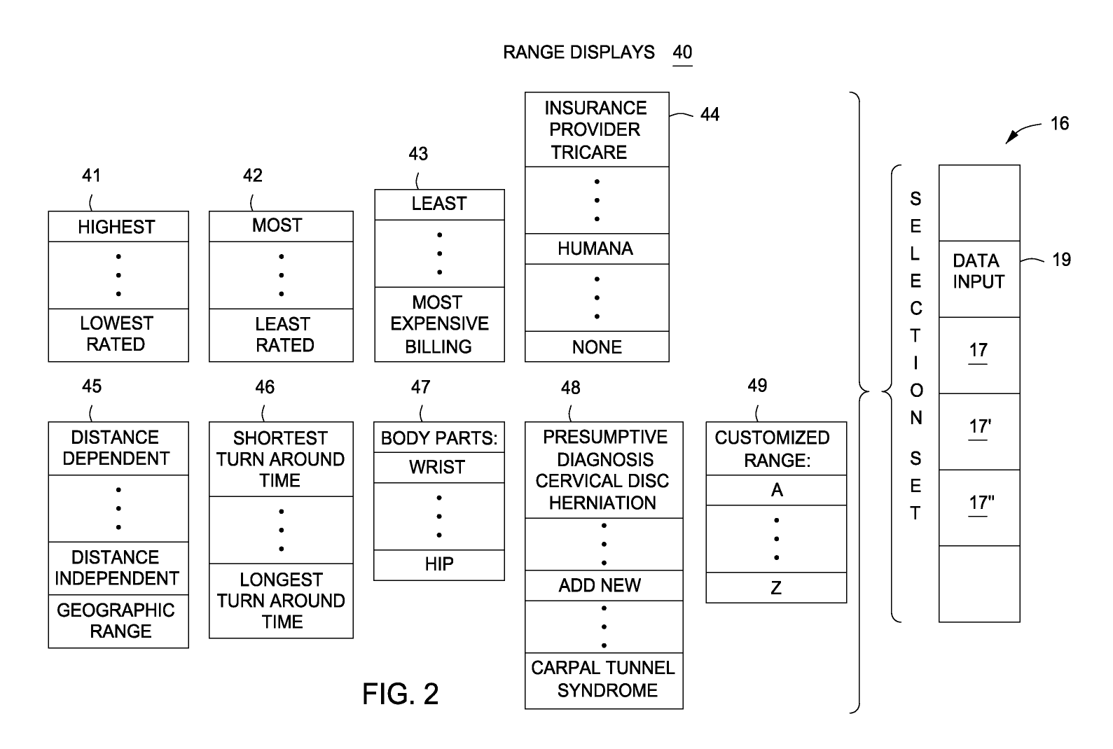

FIG. 2 schematically shows one exemplary embodiment of at least one ranged selection set 16 provided by each dashboard 15. The at least one selection set 16 receives, at least in part, shared data input 19 from a radiologic referral social network 50 in real time to assist the referring physician 3 with a current, ranged selection in either generating or augmenting a corresponding patient preorder workfile 11.

FIG. 2 further shows a graphical user interface of a range display 40 for a plurality of different selection sets 16. In particular, the following selection sets are displayed in FIG. 2: highest-lowest rated 41; most to least rated 42; least to most expensive billing 43; insurance providers 44; geographic range 45; turnaround time 46; body part 47; presumptive diagnosis 48; and a customized range 49 for implementation by the dashboard subscriber. Illustrative selection sets are as follows: patient participant preferences, such as hospitals, imaging centers; patient calendar preferences, such as time of day, day of week; patient-specific insurance company participation; patient-specific out-of pocket preferences, including co-pay options; personal patient preferences including cultural, linguistic, and religious preferences; rating range for a medical indication, such as highest rated participant by a particular diagnosis; participants conducting previous study for patient; participants providing work product according to STARK provisions requirements [42 C.F.R. §411.350 through §411.389]; security clearance preferences; military compliant preferences; government contract requirement preferences. Participants comprising radiologists would includes at least the following selection sets: ratings for previous cases; training requirements; certification and licensure requirements; past work requirements with a specific entity; affiliation with a specific entity (such as Workman's Compensation programs, personal injury law firms, sports teams); geographic locations; scheduling preferences; and follow-up study preferences. Those of ordinary skill of in the art will readily recognized that, because of the real time augmentor 12, any selection set may be removed or added to each dashboard 15 as needed.

Referring further to FIG. 1, the group application function 10, 10′ further includes a data processing function 20. The data processing function 20 is linked to the radiologic referral social networks 50, 50′, 50″ and the at least one dashboard 15, 15′. In general, the data processing function 20 prepares information received from the radiologic referral social networks 50, 50′, 50″ for use by the at least one dashboard 15, 15′ to generate or augment the patient preorder workfile 11.

As shown, the data processing function 20 includes data storage 21 for the received policy configurations that include data input. The data input includes, at least in part, shared data input. Examples of shared data input may include social network feedback, postings, and instructions received by the referring physician 3 to augment the patient preorder workfile 11. In one embodiment, the data storage 21 is provided by the group application function 10, 10′ of the health administration server 9 where the health administration server 9 comprises a plurality of servers.

The real time policy configurations processor 23 receives the policy configurations from the radiologic referral social networks 50, 50′, 50″ and policy configuration updates from an updater 24. The real time policy configurations processor 23 sends and requests policy configurations 17 from the data storage 21. Shown in FIG. 1a, the policy configurations processor 23 is linked to the regulation function 14 to provide the policy configurations 17 to the at least one dashboard 15, 15′ and to the patient preorder workfile 11.

The updater 24 processes updated policy configurations received from the radiologic referral social networks 50, 50′, 50″. In one embodiment, the updater 24 provides updated policy configurations to the real time policy configurations processor 23. Moreover, as there presently is no universally acknowledged industry quality assurance standard for the total value provided by each participant 51 such as radiologists and hospitals, updated shared data input operates to apply relative value-based productivity measures to the plurality of participants 51 from the radiologic referral social networks 50, 50′, 50″. Accordingly, in response to a patient need, a referring physician 3 relies on updated shared data input while interactively selecting from selection sets 16 within each dashboard 15 to construct a patient preorder workfile 11 before a provider order entry is created. Updated shared data input assists the referring physician 3 while selecting participants that the referring physician 3 believes will be responsive to the associated patient need, via interaction through the patient preorder workfile 11. As discussed below, the patient preorder workfile 11 further facilitates ad hoc communication sessions between the referring physician 3 and selected participants 59, such as among others at the time of diagnosis and before the patient order entry is created.

As briefly discussed above, FIG. 1a further shows the layered interoperability gateway 30. The layered interoperability gateway 30 is coupled to the health administration server 9 and the at least one radiologic referral social network 50, 50′, 50″. The layered interoperability gateway 30 joins the varied operating protocols of each radiologic referral social network 50, 50′, 50″ with the health administration server 9 while ensuring HIPAA compliance and medical privacy for medical imaging interoperability.

Specifically, the layered interoperability gateway 30 includes an Integrating Healthcare Enterprise (hereinafter “IHE”) initiative interoperability layer 31. IHE is a healthcare information technology protocol well known in the industry and administered by the Radiological Society of North America for the secured management of comprehensive patient electronic health records. The IHE initiative interoperability layer 31 facilitates interoperability of IHE format records with the health administration server 9.

The layered interoperability gateway 30 includes a DICOM interoperability layer 33 of which the IHE initiative interoperability layer 31 is layered on top of the DICOM interoperability layer 33. DICOM is a digital image file protocol well known in the industry and administered by the National Electrical Manufacturers Association (hereinafter “NEMA”) PS3 for health informatics that includes workflow and data management. The DICOM interoperability layer 33 facilitates interoperability of DICOM format records with the health administration server 9.

The layered interoperability gateway 30 includes a Health Level (hereinafter “HL”) 7 interoperability layer 35 of which the DICOM interoperability layer 35 is layered on top of the HL7 interoperability layer 35. HL7 is an application layer protocol well known in the industry and administered by the Health Level Seven, Inc. for health informatics that includes the exchange, management and integration of electronic healthcare information. The DICOM layer 33 facilitates interoperability of HL7 format records with the health administration server 9.

FIG. 1 generally shows the layered interoperability gateway 30 linked with the at least one radiologic referral social network 50, 50′, 50″. Each radiologic referral social network 50, 50′, 50″ includes a plurality of participants 51. In one embodiment, under the terms and conditions of membership, the radiology social network referral system 1 is not restrictive with respect to the number of competing prospective participants within the at least one radiologic social network 50, 50′, 50″ such that each prospective participant becomes a member of the at least one radiologic social network 50, 50′, 50″ by simply registering with the radiology social network referral system 1, such as online registration. For example, FIG. 1a shows three competing imaging center participants 60, 60′, 60″ as well as two competing radiologists 62′, 62″. Accordingly, as the radiology social network referral system 1 is social network-based, the network growth of participants as well as feedback from each participant is strongly encouraged as social network participant expansion and feedback provides updated, informed choices when interacting with the at least one dashboard 15, 15′.

As shown in the embodiment of FIG. 1a each radiologic referral social network 50, 50′, 50″ is linked with the layered interoperability gateway 30. Accordingly, those of ordinary skill in the art will contemplate a variety of networks linked to the layered interoperability network such as, among others, a world-wide-web based network 50, a virtual private network 50′ such as a hospital, and a military extranet 50″. The layered interoperability gateway 30 securely interfaces with a variety of radiologic referral social networks 50, 50′, 50″ to provide secured services to subscribers of user equipment 5, such as among others a referring physician 3.

Accordingly, in one embodiment, the patient preorder workfile 11 provides data input 19 from multiple data sources before a provider order entry is created as well as after. With each dashboard 15, the referring physician 3 interactively requests from a plurality of selection sets 16 which data input 19 is to be included with the patient preorder workfile 11 before a provider order entry is created. Illustratively, the data input 19 provided by the patient preorder workfile 11 includes, among others patient demographic information, insurance, and diagnostic information arising from a combination of selection sets 16 and at least one preorder consultation created by establishing network connection between the referring physician 3 and a plurality of participants 51 with the patient preorder workfile 11, as discussed in greater detail below.

In one embodiment, upon creation of a provider order entry 139, the patient preorder workfile 11 is sent by the referring physician 3, via either a manual eMR SEND function 999 or an automated function, to an electronic medical record system 39. Illustratively, the ERXRAY facilitates transfer of the provider order entry 139 to the electronic medical record system 39.

Illustratively, in one embodiment, a military extranet 50″ features a pool of competing radiologists and imaging centers each with a predetermined level of security clearance, satisfy a range of Medicare requirements, prequalified by the US Veterans Administration, or US government contract requirements such as among others hiring of women, minorities and disabled veterans. Selection sets for military extranet 50″ dashboards include radiologists with schedule preferences for overseas imaging. In another embodiment, a virtual private network 50′ features participants for order referral based on a combination of training, certification and affiliation. Those of ordinary skill of in the art will readily recognize that, because of the real time augmentor 12, any selection set may be removed or added to each dashboard 15 as needed.

In one embodiment, both the group application function 10, the health administration server 9, and the layered interoperability gateway 30 are linked to an electronic medical records system 39, whereas in an alternative embodiment, the group application function 10 is linked to the electronic medical records system 39. In response to a specific patient need, the patient preorder workfile 11 provides the referring physician 3 with the ability, among others, to easily make direct inquiries with providers regarding their services and goods, via the corresponding user equipment 5, on a SIP-based multimedia platform provided by the patient preorder workfile 11 before a computerized provider order entry or “order” is submitted to the electronic medical records system 39. Under current electronic medical records systems provider order entry methods, where a considerable group of health administrator personnel must first process an order in a computerized, non-interactive manner, it is difficult or non-existent for a referring physician to freely locate the most appropriate radiologic services or products while with their patient during the initial assessment. In the past, a referring physician had the flexibility of personally calling a radiologist or imaging center for a preliminary consult but present electronic medical records system protocol, such as among others PACS protocol, constrains the referring physician often to just keyboard computer entry and processing.

Illustratively referring to FIGS. 1 and 4, the referring physician 3 manually selects an electronic medical records system SEND, illustrated as “eMR SEND”, function 999 on the referring physician dashboard 200 when the referring physician 3 is ready to send the patient preorder workfile 11 along with the standard order entry to the electronic medical records system 39. However, before selecting the “eMR SEND” function 999, the referring physician 3 is free to utilize the SIP multimedia interface provided by a dashboard, 15, 15′, 100, 200′, via the patient preorder workfile, to contact various participants within the radiology social network referral system 1. In at least one other embodiment, the patient preorder workfile 11 is automatically sent to an electronic medical records system 39.

In at least one embodiment, the patient preorder workfile 11 remains functionally active after the electronic medical records system 39 receives the order and assigns a DICOM format header whereas, in an alternative embodiment, the patient preorder workfile 11 does not remain functionally active after the electronic medical records system 39 receives the order. For the embodiment of FIG. 5, a “MODE” policy configuration 134 provides status whether the order “has not”, “is in the process of” or “was received” by the electronic medical records system 39.

Operatively, a general method for radiologic practice workflow with respect to a referring physician 3 is appreciated as follows. A referring physician 3 applies selections sets 16 of policy configurations 17 to at least one dashboard 15 before an order is placed by the referring physician 3. In one embodiment, the referring physician 3 chooses selection sets 16 of policy configurations 17 to construct at least one dashboard 15. Before placing an order, the referring physician 3 chooses at least one participant of the plurality of participants 51 as a choice from a selection set 16.

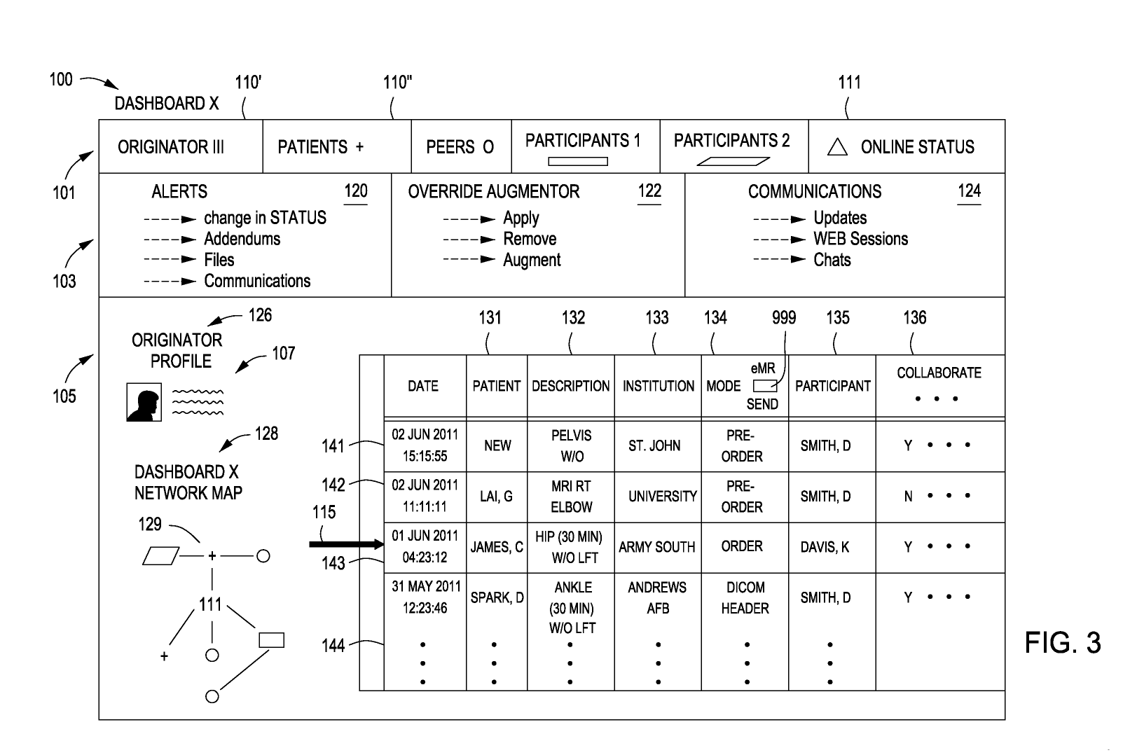

A real time augmentor 12 is linked with each dashboard 15. Accordingly, as shown in FIG. 3, each dashboard 100 includes a real time override augumentor 122. The override augmentor 122 is a graphical user interface for the real time augmentor 12 as shown in FIG. 1a.

In FIG. 1a, the dashboard 15 further includes a plurality of ranged selection sets 16 of policy configurations. Policy configurations 17, shown with respect to graphical user interface in FIG. 3 as policy configurations 131, 132, 133, 134, 135, 136, are updated in real time with shared data input 19 received at the group application function 10 of the remote radiology social network referral system 1. One selection set 16 comprises a plurality of participants 51 from the radiology social network referral system 1.

By establishing a secure, network connection, the patient preorder workfile 11 further facilitates ad hoc communication sessions between the referring physician 3 and selected participants 51, such as among others at the time of diagnosis and before the patient order entry is created. Specifically, the referring physician 3, in response to a patient need, generates a patient preorder workfile 11 with the at least one dashboard 15. To form a secured request workgroup 53, the patient preorder workfile 11 establishes a network connection between the referring physician 3 and the plurality of participants 51 responding to an invitation message. The invitation message is sent to at least one participant of the request workgroup 53. In one embodiment, the established network connection is made with the referring physician 3, the patient preorder workfile 11, and the participants of the plurality of participants 51 responding to an invitation message, such as, among others, in the manner of a multimedia conference session.

The patient preorder workfile 11 collects shared and private data input 19. In one embodiment, shared data input is provided such that the shared data input corresponds to each responding participant within the plurality of participants 51 that provides data input for the plurality of participants 51 to access.

Illustratively, in one embodiment, a work request group 53, 53′ is formed for collecting data input with the patient preorder workfile 11. The work request group 53, 53′ includes at least one participant, such as a radiologist, and the referring physician 3.

FIG. 1a illustratively shows a first work request group 53 and a second work request group 53′ each created from the plurality of participants 51 of the radiology referral social network 50. In operation, on receipt of a patient preorder workfile 11, various participants 51 receive and respond to the patient preorder workfile 11, such as among other participants that produce work product. For example, as shown in FIG. 1a, each respective imaging center 60, 60′, 60″ creates a corresponding imaging report 60a, 60′a, and 60″a; each respective radiologist 62′ creates a corresponding radiologist report 62′a; and each peer 64 may optionally create peer report 64a.

The patient preorder workfile 11 integrates with a computerized physician order entry 139. In response to a patient need, the patient preorder workfile 11 is sent with a computerized physician order entry 139 to the electronic medical records system 39 with a manually executed send feature 999 on the at least one dashboard 11.

After integration as well as receipt of the computerized physician order entry 139 by the electronic medical records system 39, the patient preorder workfile 11 maintains activation and remains linked with the dashboard 15. Through a layered interoperability gateway 30, a radiologist interfaces with the integrated physician order entry 139 and the patient preorder workfile 11 to create a radiologist report 62′a. Accordingly, in one embodiment, a patient preorder workfile 11 integrates with a radiologist report 62′a.

In one embodiment, the policy configurations 17 are updated as a function of feedback evaluations received from each participant within the radiology social network referral system 1. At anytime, however, a patient preorder workfile 11 is altered with the real time augmentor 12. In one embodiment, the real time augmentor 12 alters workflow status of at least one participant from the plurality of participants' 51 selection set 16. Accordingly, in one embodiment, a combination of a referring physician, a radiologist, and an imaging center can alter the patient preorder workfile 11 with their respective UE 5. In one embodiment, the real time augmentor 12 alters at least one participant from the plurality of participants 51.

Illustratively, altering the patient preorder workfile 11 includes the following, among others. Amending, including adding and subtracting, the patient preorder workfile 11 alters the chosen sets 16 of policy configurations 17 applied to the at least one dashboard 15. Amending the workflow status of the patient preorder workfile 11 with respect to a plurality of patient preorder workfiles. Amending the at least one dashboard 15 alters the patient preorder workfile 11. Amending the collected data input based on updated shared data input alters the patient preorder workfile 11.

A general method for a preorder radiology workflow is appreciated as follows. A radiologic referral social network 50 having a plurality of participants 51 is established. The plurality of participants 51 includes a referring physician 3 and at least one radiologist 62′. A group application function 10 exchanges information with the radiologic referral social network 50 and supplies shared information, including shared data input from participants 51 within the radiologic referral social network 50.

A referring physician 3 applies selections sets 16 of policy configurations 17 to at least one dashboard 15. In one embodiment, the referring physician chooses selection sets 16 of policy configurations to construct at least one dashboard 15. In FIG. 1a, the dashboard 15 further includes a plurality of ranged selection sets 16 of policy configurations 17.

A real time augmentor 12 is linked with each dashboard 15. Accordingly, as shown in FIG. 3, each dashboard 100 includes a real time override augumentor 122. Shown in FIG. 3, each dashboard 100 includes a real time an override augumentor 122 such that the override augmentor 122 is a graphical user interface for the real time augmentor 12 of FIG. 1a.

The policy configurations 17, shown with respect to graphical user interface in FIG. 3 as policy configurations 131, 132, 133, 134, 135, 136, are updated in real time with shared data input 19 received at the group application function 10 of the remote radiology social network referral system 1. In one embodiment, the policy configurations are updated as a function of feedback evaluations received from each participant within the radiology social network referral system 1.

In response to a patient need, the referring physician 3 generates a patient preorder workfile 11 with the at least one dashboard 15. To form a secured request workgroup 53, the patient preorder workfile 11 establishes a network connection between the referring physician 3 and the plurality of participants 51 responding to an invitation message. The patient preorder workfile 11 collects shared and private data input 19.

In one embodiment in establishing a network connection for the radiologic social network 50, an invitation message, in response to the patient preorder workfile 11 command, is sent to a supervising participant 162′ of a request workgroup 53 in such a way that the invitation message is configured to permit the at least one participant of the plurality of participants 51 to change the particular participants that are subsequently receiving the invitation message. As illustrated in FIG. 1a, the supervising participant 162′ comprises a radiologist. In one embodiment, an invitation message is configured by the patient preorder workfile 11 to permit the supervising participant 162′ to change the particular participants that are subsequently receiving the invitation message. In one embodiment, an invitation message is configured by the patient preorder workfile 11 to permit at least one participant, such as a radiologist, to block particular participants from receiving future invitation messages.

In one embodiment, an invitation message is simultaneously sent to at least one request workgroup 53, 53′ based on the updated policy configurations, such as, among others, rankings, peers, and first available which can be agreed by members of each participant of the request workgroup 53, 53′, such as either beforehand or in real time. Alternatively, the invitation message is sequentially sent to at least one request workgroup 53, 53′ based on updated policy configurations.

In one exemplary method, the patient preorder workfile 11 integrates with a computerized physician order entry 139. Accordingly, a file header for an electronic medical records system of a type well known in the industry, such as among others a DICOM header, is assigned to the patient preorder workfile 11 during integration with the computerized physician order entry 139. After integration as well as receipt of the computerized physician order entry 139, the patient preorder workfile 11 maintains activation and remains linked with the dashboard 15.

At anytime, however, the real time augmentor 12 can alter a patient preorder workfile. Optionally, the real time augmentor 12 can alter at least one participant's status from the plurality of participants 51.

Moreover, a general method for real time message compression is appreciated as follows. A referring physician 3, in response to a patient need, generates a patient preorder workfile 11 based on real time policy configuration updates derived from shared data input received at a group application function 10 of a remote radiology social network referral system 1. Policy configurations 17, shown with respect to at least one graphical user interface in FIG. 3 as policy configurations 131, 132, 133, 134, 135, 136, are updated in real time with shared data input 19 received at the group application function 10 of the remote radiology social network referral system 1.

The group application function 10 creates an invitation message associated with the patient preorder workfile 11. To form a secured request workgroup 53, the patient preorder workfile 11 establishes a network connection between the referring physician 3 and the plurality of participants 51 replying to the invitation message. In one embodiment, the established network connection, such as among others in the manner of a multimedia conference session, is made with the referring physician 3, the patient preorder workfile 11, and at least one participant responding to an invitation message of the plurality of participants 51. The invitation message is sent to at least one participant of the request workgroup 53. The patient preorder workfile 11 collects shared and private data input 19.

The patient preorder workfile 11 integrates with a computerized physician order entry 139. Accordingly, a file header for an electronic medical records system, such as among others a DICOM header, is assigned to the patient preorder workfile 11 during integration. In response to a patient need, the patient preorder workfile 11 is sent with a computerized physician order entry 139 to the electronic medical records system 39, via a manually executed send feature, for example among others the eMR SEND 999, on the at least one dashboard 11. After integration as well as receipt of the computerized physician order entry 139, the patient preorder workfile 11 maintains activation and remains linked with the dashboard 15.

Referring now to FIG. 3, generally shows one embodiment of at least one graphical user interface of a referring physician dashboard 100. The referring physician dashboard 100 is used to create, manage, and augment each active patient preorder workfile 11 as discussed above. Those of ordinary skill in the art will recognize other graphical user interfaces for creating, managing, and augmenting a patient preorder workfile 11 for each corresponding patient.

Specifically, so that a referring physician, combat medic, and administrator can access other dashboards as shown, the referring physician dashboard 100 includes dashboard tabs 101. In some embodiments, access to other dashboards is user-restricted. For example, a tab with a corresponding icon is provided, among others, for an ORIGINATOR III 110′, PATIENTS+110″, and PARTICIPANTS 2 111. The participants 2 tab 111 for the embodiment of FIG. 4 provides a data field box for customized entry of a particular PARTICIPANT, such as a radiologist. Moreover, for the dashboard 100 of FIG. 3, the dashboard tabs 101 graphically displays the present online status the referring physician 3 that is shared throughout the radiology social network referral system 1.

The dashboard 100 includes a plurality of activity windows 103. As shown, one activity window 103 is an ALERTS window 120. In operation, the ALERTS window 120 highlights issues that need the referring physician's heightened attention. Another activity window 103 is a COMMUNICATIONS window 124. The COMMUNICATIONS window 124 enables multimedia messaging, such as 3GPP LTE SIP messaging, from the referring physician 3 to the plurality of participants 51 within the radiology social network referral system 1 or to patients 4. As discussed briefly above, one activity window 103 is the override augmentor 122. The override augmentor 122 enables alteration of patient preorder workfiles before, during, and after an order is placed by the referring physician.

The dashboard 100 further includes a status command window 105. The status command window 105 includes a network display 107 and a preorder status command display 109. As shown, the network display 107 includes an originator profile 126. The originator profile 126 displays the personal profile of the referring physician 3 and the referring physician's reviews in detail.

The network display 107 includes a network map 129. Illustratively, the network map 129, in one embodiment, comprises a symbolic network map 128 providing status of frequently accessed participants from the plurality of participants 51 and the present online status for each participant is graphically displayed. As shown, the network map 129 is oriented relative to a symbolic representation of the referring physician 129.

For the embodiment of FIG. 3, the preorder status command display 109 includes a scrollbar access function 115 for quickly and easily scrolling as well as accessing a plurality of patient preorder workfiles 141, 142, 143, 144. The preorder status command display 109 identifies policy configurations 131, 132, 133, 134, 135, 136. Categorized, updated data input that will be provided with each patient preorder workfile 141, 142, 143, and 144. Illustratively, FIG. 4 shows a patient policy configuration 131, a description policy configuration 132, an institution policy configuration 133, a mode policy configuration 134, a participant policy configuration 135, and a collaborate policy configuration 136. As discussed above, the preorder status command display 109 includes the eMR SEND button 999 with the mode policy configuration 134.

FIG. 4 specifically shows one embodiment of a graphical user interface of a referring physician dashboard 200. A real-time augmentation function 122 is shown on the referring physician dashboard 200 with augmentation status engaged. As such, the referring physician dashboard 200 shows a plurality of patient preorder workfiles. Illustratively, for a new patient preorder workfile 141, a referring physician chooses an imaging center from a plurality of participant types at window 210 as input into field box 134a. A pull-down window 215 enables the referring physician to choose a specific imaging center from the ranged selection sets of imaging centers 215 as an input entry into field box 141a. As imaging center “D” is shown as a chosen, a pull-down window 220. The pull-down window 220 enables the referring physician to further choose from a selection set having a range of highest rated imaging center technologists for imaging center “D” based on shared information data received from a radiology social network referral system.

FIG. 5 shows one embodiment of a graphical user interface of a referring physician dashboard 200 as shown in FIG. 4. For illustrative purposes, the referring physician chooses an individual radiologist at window 225 from the ranged selection sets for insertion into a field box 135. At widow 230, the referring physician is provided selection sets with shared data input including ratings and reviews obtained in real time from the radiology social network referral system 1. In particular, the referring physician chooses a radiologist from the highest rated at window 232 and most rated at window 233. At window 235, the referring physician chooses from a range of insurance providers mutually shared by the radiologist and corresponding patient. A radiologist currently with the shortest turnaround time is selected at window 240.

At window 245 a possible mutually agreeable discount between the radiologist and corresponding patient is selected. For example, a radiologist that provides a 25% billing discount during a busy time of the week if the patient is willing to postpone receipt of a radiologist report for one additional day longer.

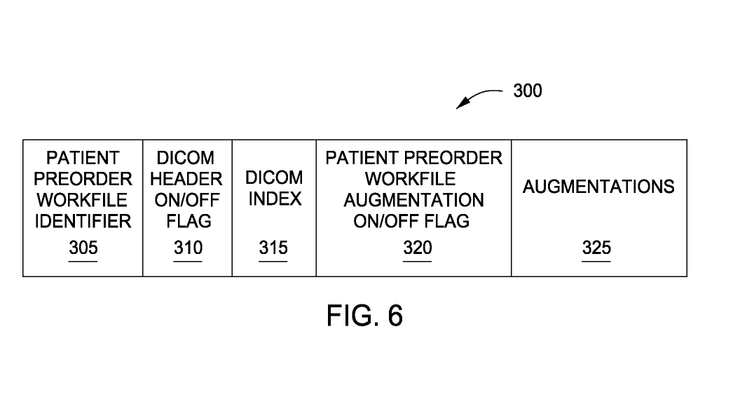

FIG. 6 is a bit layout of one illustrative embodiment of a patient preorder workfile packet header 300. In one exemplary embodiment, the patient preorder workfile packet header 300 defines, at least in part, an invitation message to form a secured request workgroup 53. Furthermore, in one exemplary embodiment, the patient preorder workfile packet header 300 comprises applied to a SIP based message. For illustrative purposes, the patient preorder workfile packet header 300 comprises a DICOM file header. Those of ordinary skill in the art will readily recognize that the patient preorder workfile packet header 300 may be applied to file headers for an electronic medical records system of a type well known in the industry.

Accordingly, as shown, a patient preorder workfile identifier 305 is provided and corresponds to a specific patient. Next, a DICOM header on/off flag 310 is provided to determine whether a DICOM header has been filed for the patient order. If a DICOM header is filed, the specific DICOM header is provided at the DICOM Index 315. The patient preorder workfile packet header 300 provides a patient preorder workfile augmentation on/off flag 320 to determine whether at least one alteration to the patient preorder workfile 11 has been made. If at least one alteration is required to the patient preorder workfile packet header 300 such alterations are provided at 325. Once the alteration is made with respect to the patient preorder workfile 11 or dashboard 15, 15′, the revised patient preorder workfile 11 or dashboard 15, 15′ is saved in memory, such as the data storage 21.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “coupled” and “linked” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I claim:

1. A method for rating participants in a radiological referral communication system comprising the steps of:
inputting rating data;
linking a participant to the data; and
displaying the ratings data in response to a search query.

2. The invention in claim 1, further comprising the step of viewing based on data that is subjective.

3. The invention in claim 1, further comprising the step of sorting based on data that is subjective.

4. The invention in claim 1, further comprising the step of viewing based on data that is objective.

5. The invention in claim 1, further comprising the step of sorting based on data that is objective.

6. The invention in claim 1, further comprising the step of viewing based on data that is objective and subjective.

7. The invention in claim 1, further comprising the step of sorting based on data that is objective and subjective.

8. A method for bidding for the most advantageous medical service.

9. The invention in claim 8, wherein said bidding takes place by following a processor-based algorithm that further comprises the steps of:
inputting information for a patient preorder workfile;
linking the patient preorder workfile with corresponding information on the radiological referral communication system;
inputting display settings for the corresponding information on the radiological referral communication system; and
displaying the linked corresponding information in response to a search query.

10. The invention in claim 9, wherein the corresponding information comprises distance information.

11. The invention in claim 9, wherein the corresponding information comprises participant ratings.

12. The invention in claim 9, wherein the corresponding information comprises schedule information.
